(19) United States
(12) Patent Application Publication
(10) Pub. No.: US 2018/0017214 A1
(43) Pub. Date: Jan. 18, 2018

(54) COMPOSITE LPG TANK TRAILER

(71) Applicant: Heil Trailer International, Co., Cleveland, TN (US)

(72) Inventors: Jason Hermiller, Lebanon, OH (US); Ben Dietsch, Kettering, OH (US); Jason Rice, Dayton, OH (US); Brian Henslee, Galloway, OH (US); Kelly Ridout, New Paris, OH (US); Bryan Yielding, Riceville, TN (US); Jian Feng Tong, Dallas, TX (US)

(21) Appl. No.: 15/649,928

(22) Filed: Jul. 14, 2017

Related U.S. Application Data
(60) Provisional application No. 62/363,055, filed on Jul. 15, 2016.

(51) Int. Cl. F17C 1/16; B60P 3/22; F17C 13/08; B29D 22/00; G01F 23/02; B29K 63/00

(52) U.S. Cl. CPC F17C 1/16; B29D 22/003; G01F 23/02; B60P 3/2215; B60P 3/225; F17C 13/083; B29K 2063/00; B60G 2300/042; F17C 2203/016; F17C 2203/0663; F17C 2205/0352; F17C 2221/032; F17C 2201/0109

(57) ABSTRACT

A tank trailer has a container formed from a tubular body and one or more polar bosses coupled to distal ends of the tubular body. The trailer includes a pumping system that has one or more pipes fluidly coupled to the interior of the container via an interface at one of the polar bosses. The tank trailer may have a base support and one or more circumferential support members coupling the base support to the composite container, or the support functionality of the base may be instead accomplished by the container. The one or more polar bosses may include an inner circular surface and an outer circular surface, wherein the outer circular surface has one or more flat portions that complement and engage one or more concave features of the substantially tubular body.

### CROSS-REFERENCE TO RELATED APPLICATIONS

This application claims the benefit of and priority to U.S. Provisional Application No. 62/363,055, filed Jul. 15, 2016, which is hereby incorporated by reference.

### BACKGROUND OF THE DISCLOSURE

The present disclosure relates to tank trailers used to transport fluids, such as liquefied petroleum gas.

### SUMMARY

In accordance with an illustrative embodiment, a tank trailer includes a container having a composite, substantially tubular body and a polar boss coupled to a distal portion of the substantially tubular body. The substantially tubular body includes an inner tubular portion and an outer shell, and the polar boss is positioned between the inner portion and outer shell of the substantially tubular body.

In accordance with another illustrative embodiment, a method of forming a tank trailer includes forming a container having a composite, substantially tubular body and a polar boss coupled to a distal portion of the substantially tubular body, and coupling a cover plate to the polar boss of the container.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1A is a side view of a liquefied petroleum gas (LPG) tank trailer coupled to a tractor;

FIG. 1B is a detail view of a front portion of the tank trailer shown in FIG. 1A;

FIG. 2A is a side view of a tank trailer container, analogous to the container shown in FIG. 1A;

FIG. 2B is a partial section view taken along the line 2B-2B of FIG. 2A, showing an interface between a tubular portion of the container and polar boss, in accordance with an illustrative embodiment;

FIG. 2C is a partial section view taken along the line 2C-2C of FIG. 2A, showing an interface between a tubular portion of the container and polar boss, in accordance with an illustrative embodiment;

FIG. 3 is a perspective view of the polar boss referenced with regard to FIG. 2B;

FIG. 4 is an exploded view of a portion of a container, analogous to the container shown in FIG. 2A;

FIG. 5 is a partial perspective view of a front portion of a tank trailer, showing an illustrative pumping system;

FIG. 6 is a partial perspective view of a front portion of a tank trailer, with the tubular portion of the container hidden, showing an interface between the pumping system and the container; and

FIG. 7 is a schematic diagram of the pumping system of FIGS. 5 and 6.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

Liquefied petroleum gas (LPG) transports typically include tank trailers having a cylindrical steel tank with hemispherical ends. Such tanks typically are completed using an upper coupler kingpin and back axle assemblies. A pump and/or valve ports for LPG product filling and emptying are typically located on the underside of the tank near the center of the length of the tank, just aft the landing gear of the trailer.

In many areas of the United States and Canada, the total weight of the tractor, trailer, and payload is limited by regulation. For example, LPG transports in much of the US are subject to a weight limit of 80,000 lbs. The weight of the steel tank system limits the amount of LPG that can be transported, thus limiting the economic efficiency of the process of transporting LPG. The present disclosure relates to a larger and lighter weight tank that allows for more LPG to be transported while remaining under the applicable weight limit, which can also withstand an internal gas pressure up to 1,325 pound per square inches, and is applicable to tandem axle trailers (front and rear lift axles), pup trailers, and other similar types of transports.

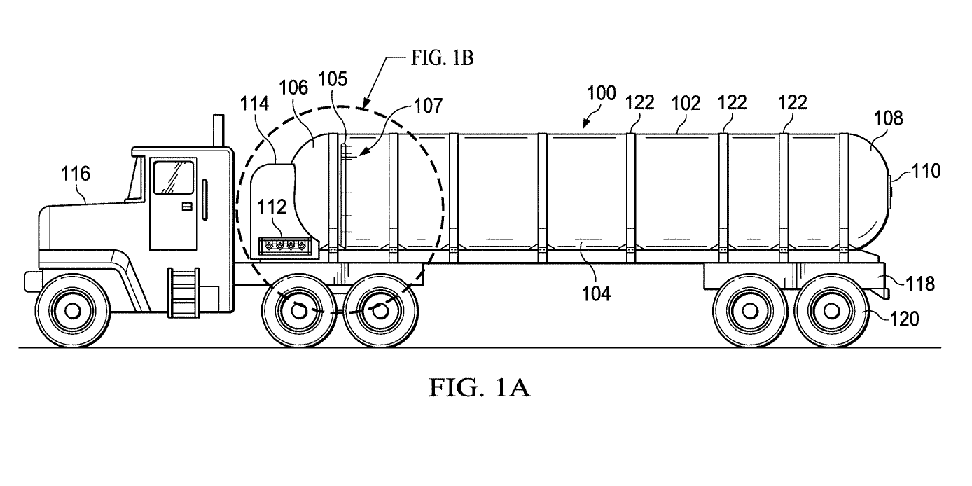

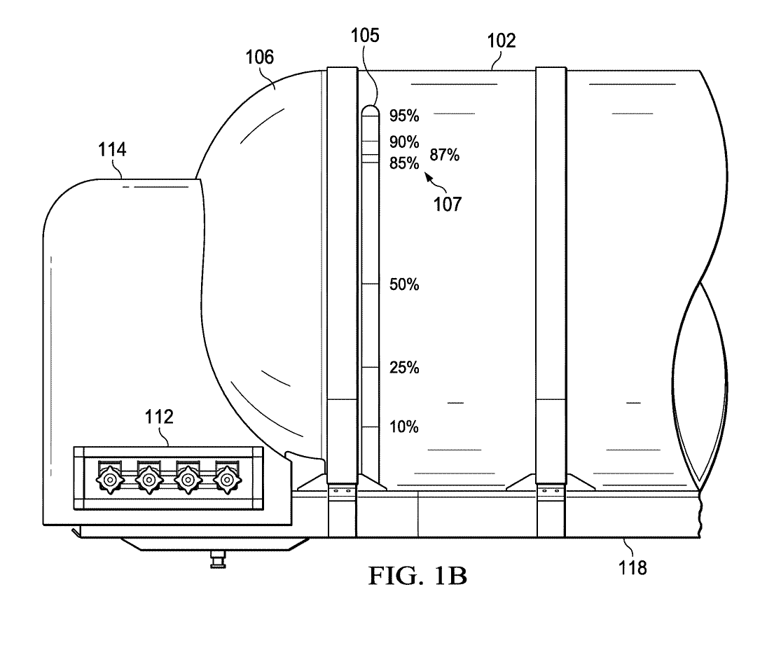

Turning now to FIGS. 1A and 1B, an illustrative embodiment of a tank trailer 100 is shown coupled to a tractor 116. The trailer includes a container 102 formed by a tubular, or substantially tubular member or body 104 coupled to a front portion 106 and rear portion 108, which are described in more detail below. The tubular member 104 may be a composite mandrel that is made from a composite material and left in place to form a structural component of the container 102 of the tank trailer 100. The tubular member is substantially tubular and may include portions or cross sections of varying internal or external diameter, eccentric cross sections, and distinct flattened or concave portions to, for example, mate with complementary components when assembled. The tubular member may also be referred to as a substantially tubular body. The container 102 includes an access port 110 at the rear portion 108, and a pumping subsystem 112 fluidly coupled to the front portion 106 of the container 102. The trailer 100 is supported by a chassis 118 that is coupled to the tractor 116 at the front portion 106 to a rear axle assembly 120 near the rear portion 108. In some embodiments, the chassis may include a landing support (not shown) and one or more additional axle assemblies.

The pumping subsystem 112 may be a pumping and piping system located at the front portion 106 of the tank container 102. This location of the pumping system may allow more product to be removed with the tank container 102 and the tank container 102 is positioned at a slope such that product in the tank pools near to ingress point of the pumping subsystem 112. To that end, the trailer 100 may include a lifting feature, such as a hydraulic lift, to tilt the front portion 106 down relative to the rear portion 108 (or the rear portion 108 up relative to the front portion) to facilitate near complete emptying of the tank container 102 contents. In another embodiment, the orientation of the trailer 100 may be substantially reversed and the pumping subsystem 112 may be positioned at the rear portion 108 of the trailer.

The chassis 118 may generally be considered to be a frame that attaches to and supports straps 122 to secure the tank container 102 to the frame or chassis 118. The chassis 118 is connected to the suspension/wheel assembly and the kingpin assembly. In some embodiments, the chassis may be discontinuous and formed by separate frame components that do not directly couple to one another such that a portion of the tank container 102 is not directly vertically unsupported (by the chassis). In such am embodiment, the chassis 118 may include a front portion that couples the trailer 100 to the tractor 116 and a rear portion that couples to the rear axle assembly 120, with the composite tank functioning as both a container and a connection structure between the front and rear portion of the chassis 118. The straps 122 may be fastened about the tank container 102 using a variable tensioning device (e.g., a spring) to account for expansion and contraction of the tank container 102 while still providing adequate force to fasten the tank container 102 to the chassis 118 during operation.

The portion of the pumping subsystem 112 that is positioned in front of the front portion 106 may be shielded during operation by a cover 114 or fairing. In addition, the tubular member 104, front portion 106, or rear portion 108 may include a translucent portion 105, or window, having a visual indicator 107 to indicate the fill level of the container 102.

As described in more detail below, the container 102 is generally formed from a composite material, such as a carbon fiber reinforced or fiber glass reinforced polymer composite material. The composite material may be, for example, a bi-layer structure formed from an inner glass fiber reinforced vinyl ester composite overwrapped with a glass or carbon fiber reinforced epoxy composite. The epoxy composite is preferably an epoxy composite fabricated with an epoxy resin that cures without the use of oven or autoclave, and that can still produce high-glass transition temperature. The epoxy composite may be a high-performance composite similar to a composite that is cured with a conventional high-temperature oven or autoclave-cured composite. The epoxy resin in the epoxy composite may be cured by a self-generated heat from an exothermic reaction of the resin. Examples of such epoxy composites and epoxy resins include those made by NONA Composites of Dayton Ohio, including without limitation NONA R102/H11 and R404/H18 Infusion Epoxy Resins. Other examples include Diglycidyl ether of bisphenol A, diglycidyl ether of bisphenol F, resorcinol diglycidyl ether, N,N-Diglycidyl-4-glycidyloxyaniline, brominated diglycidyl ether of bisphenol A, novolac epoxy, tetraglycidyl meta-xylenediamine, 1,4-butanediol diglycidyl ether, 4,4′-Methylenebis(N,N-diglycidylaniline), tris(4-hydroxyphenyl)methane triglycidyl ether, tris(2,3-epoxypropyl)isocyanurate, and combinations thereof; and epoxy curing agents.

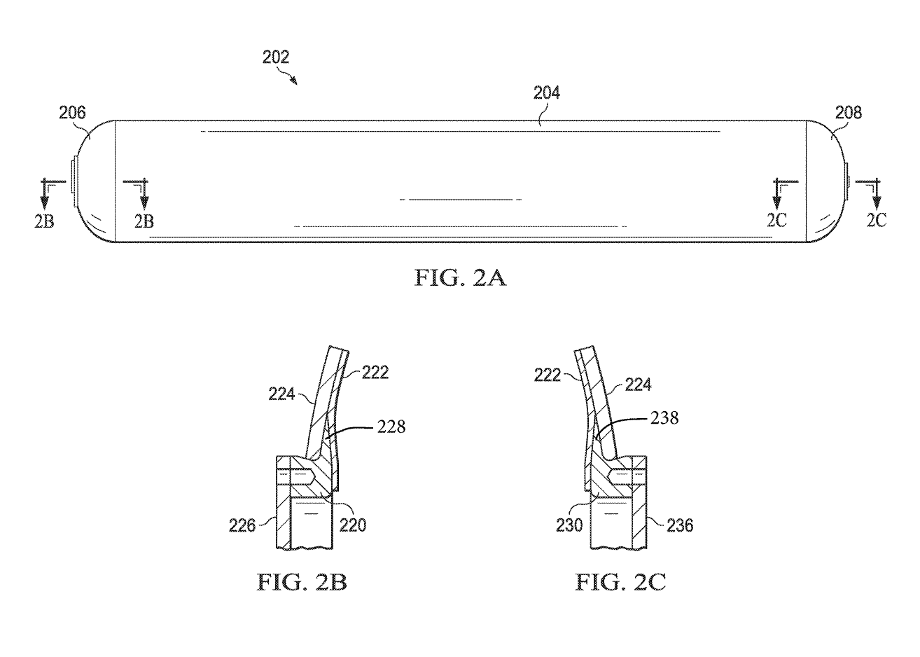

In an illustrative embodiment, as shown in FIGS. 2A-2C, a container 202 includes a barrel portion 204, a front portion 206, and a rear portion 208. As shown in more detail in FIG. 2B, the front portion 206 includes a joint between an inner tubular portion 222 of the barrel portion 204 and a front polar boss 220. The terms “front” and “rear” are used herein to refer to opposing distal portions and that the orientation of the referenced features may be reversed without materially affecting the functionality of the illustrative embodiments.

An angled, flange portion 228 of the front polar boss 220 is bonded between a portion of the inner tubular portion 222 and an outer shell 224 of the front portion 206. The inner tubular portion 222 is generally formed from (for example) an inner glass fiber reinforced vinyl ester composite, while the outer shell 224 is generally formed (for example) from a carbon fiber reinforced epoxy composite. Other exemplary materials include metal, such as an aluminum or steel, overwrapped with a fiber reinforced polymer composite. The front polar boss 220, which may generally be formed from steel, such as stainless steel, carbon steel, or a CorTen (R) steel, is coupled to a front plate 226 which, as described below, provides an interface to a pumping subsystem. A vinyl ester resin may be used to bond the inner tubular portion 222 to the front polar boss 220.

As shown in more detail in FIG. 2C, the rear portion 208 includes a joint between an inner tubular portion 222 of the tubular member 204 and a rear polar boss 230, which is analogous to the joint described above with respect to the front polar boss 220. The angled, flange portion 238 of the rear polar boss 230 is bonded between a portion of the inner tubular portion 222 and outer shell 224 of the rear portion 208. In another embodiment, a shear-ply layer is placed between the outer shell 224 and outer the angled, flange portion (228 or 238) of the front or rear polar boss (220 or 230, respectively) as an interface. This shear-ply element placed at the described interface allows mitigation of the relatively high shear strains that occur between the composite container material and the polar boss. The rear polar boss 230, which may also be formed from steel, is coupled to a rear plate 236 which, as described below, provides an interface to an access port, such as a hatch.

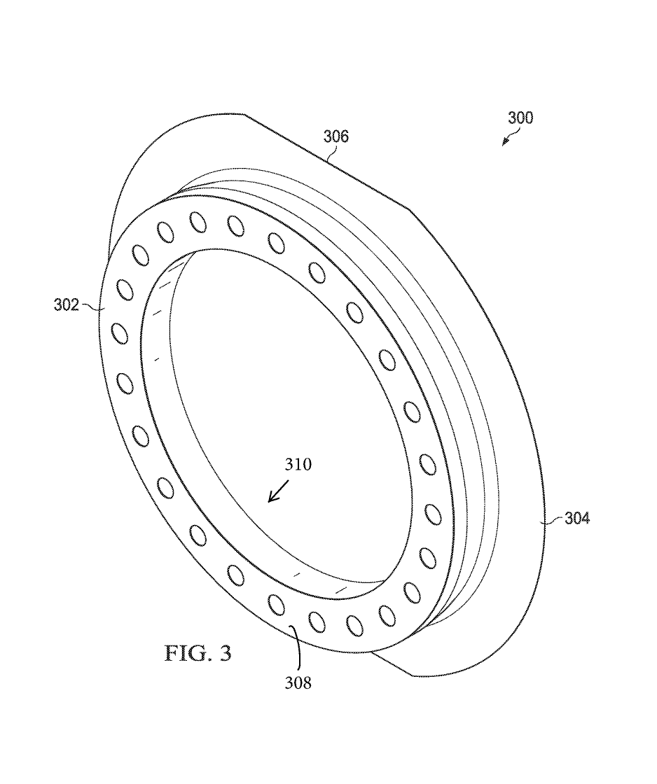

An illustrative embodiment of a polar boss 300, analogous to the polar bosses referenced with regard to FIGS. 2A-2C, is described with regard to FIG. 3. The polar boss 300 is a generally circular component having a tapered interface 304 (see angled, flange portions 228, 238 referenced above) for joining with a front or rear portion (e.g., 206 or 208), as described above. The polar boss 300 also includes a first, outward-facing side 302 that comprises a plate-mounting surface 308 and a second, inward-facing surface 310. The otherwise round outer surface of the polar boss 300 includes one or more flat portions 306, which may correlate to complementary portions of the inner tubular portion (e.g., 222) to prevent rotation of the inner tubular portion relative to the polar boss 300 during and after assembly.

When assembled, the polar boss 300 may be generally understood to be an integrated polar boss, which is metallic ring shaped component that is partially enclosed between an inner tubular portion and the outer shell of the tubular member. In an illustrative embodiment, the boss is configured to be a structure that functions as a mounting interface for additional components, such as a cover plate.

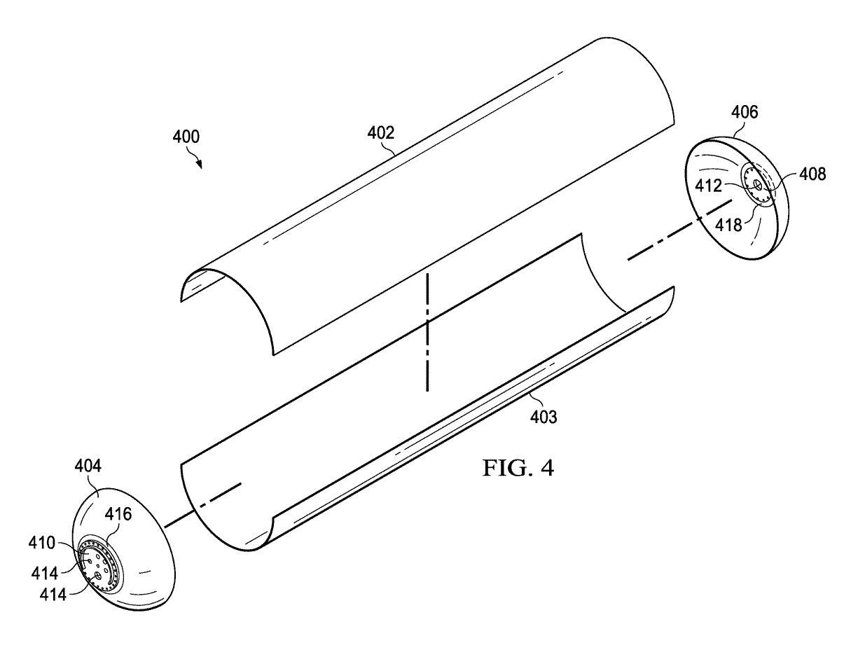

FIG. 4 provides an exploded view of components that may be joined to form a composite tank 400. The tank 400 includes one or more cylindrical segments 402, 403 that may be joined to form the cylindrical portion of the tank 400. A front polar cap 404 is positioned at a front end of the tank 400 and a rear polar cap 406 is positioned at a rear end of the tank 400. The front polar cap 404 is bonded to a front polar boss 416. In turn, a front cover plate 410 having piping system ports 414 is affixed to the front polar boss 416, and may be considered to be a pumping system interface. Similar to the front polar cap, the rear polar cap 406 is bonded a rear polar boss 418. A rear cover plate 408 having an access port 412 is coupled to the rear polar boss 418.

The tank 400 generally comprises a fiberglass composite construction with the front polar boss 416 and rear polar boss 418 being constructed from steel. The tank segments 402, 403 may similarly be fabricated from glass fiber reinforced polymer composite or polymer composite made with a combination of glass and carbon fiber reinforcement. The polar bosses 418, 418 may be constructed from the same or similar materials, in addition to or instead of steel.

In some embodiments, the tank 400 includes a an inner tubular portion that serves as a pre-cured inner leave-in mandrel that is tubular member fabricated by conventional polymer composite layup processes from multiple individual fiberglass reinforced polymer composite components that are bonded together. The tank includes the first polar cap 404 and second polar cap 406, each of which is joined to the cylindrical portion of the tubular member assembly. Each of the polar bosses 416, 418 is bonded to the outside of the inner tubular portion. In an embodiment, the polar bosses 416, 418 and inner tubular portion are overwrapped with fiber saturated with liquid resin using a filament winding process. The entire assembly is then heat cured to become a single piece solid composite tank. This process creates an outer composite shell that serves as the main structure of the tank 400. The outer layer bonds to the inner tubular portion during the fabrication process, effectively creating a one piece solid composite tank. In an illustrative embodiment, the inner tubular portion material is a fiberglass and vinyl ester resin based composite material and the outer layer is a fiberglass and epoxy resin based composite material.

It is noted that vinyl ester and epoxy resins may be used on either layer depending on the tank lading and the required compatibility with the lading material. In an alternative embodiment, the tank 400 may have a thermoplastic liner for material containment, which is overwrapped with fiber saturated with resin to create a structural shell.

In an illustrative manufacturing process, fabrication of the tank 400 includes fabricating the inner composite tubular components, such as the barrel segments 402, 403, first polar cap 404, and second polar cap 406 using a fiberglass or vinyl ester. The polar bosses 416, 418 may then be bonded to the first polar cap 404 and second polar cap 406, respectively, with vinyl ester or another suitable bonding material. The container may then be completed by using a filament wind process to form an outer layer that encases a portion of the polar bosses 416, 418, the first polar cap 404, second polar cap 406, and barrel segments 402, 403. The winding process may be completed using NONA R404/H18 epoxy or any other suitable material. The filament winding process involves winding tensioned filaments over the rotating inner tubular barrel. The winding filaments are impregnated with resin by passing the filaments through a resin bath as they are wound about a tool die. The tubular barrel rotates around a spindle while a delivery eye on a carriage traverses horizontally in line with the axis of rotation of the tubular barrel, laying down fibers in the desired pattern or angle on the tubular barrel. Once the tubular barrel is completely covered to the desired thickness, the part can be cured to produce the composite tank. Following the winding process and curing, the tank 400 may be painted to complete the tank assembly.

Referring again to FIG. 1A, the tank container 102 is held onto the chassis 118 using straps 122. The straps 122 may be metal straps oriented around the circumference of the tank container 102 at multiple locations along the length of the chassis 118. The number and positioning of the 122 may be selected based on the overall length of the chassis 118 and tank container 102. A rubber material (not shown) may be placed in between the straps 122 and the tank container 102.

Typical LPG transport trailers include pump and piping features for LPG lading filling and emptying. Such pumping operations are typically located on the bottom of the tank in between the kingpin and the rear suspension system—near the midpoint of the trailer tank. In accordance with an illustrative embodiment of the present disclosure, however, a pumping subsystem is instead coupled to the front cover plate 412 affixed to the front polar boss 416.

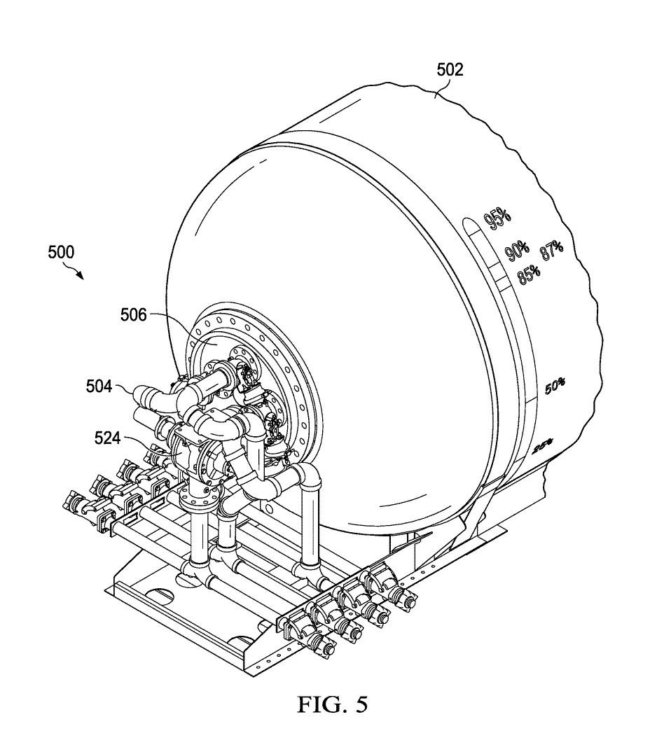

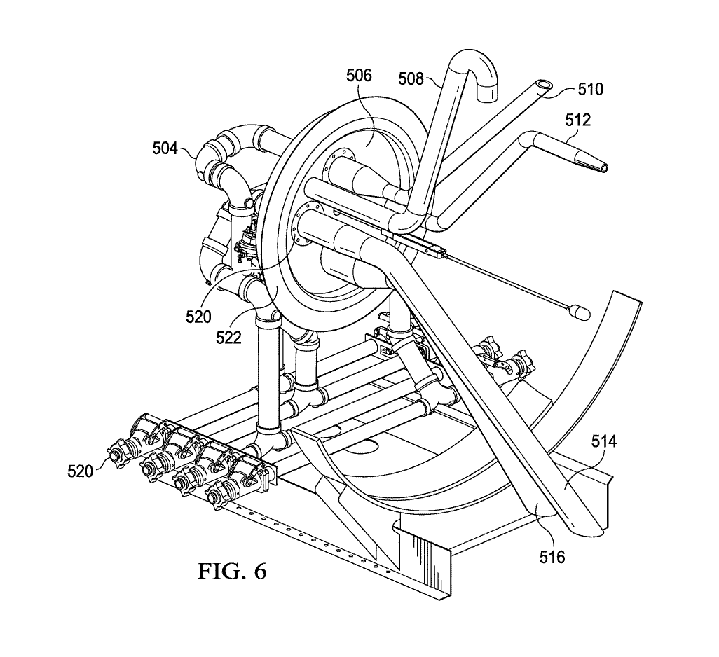

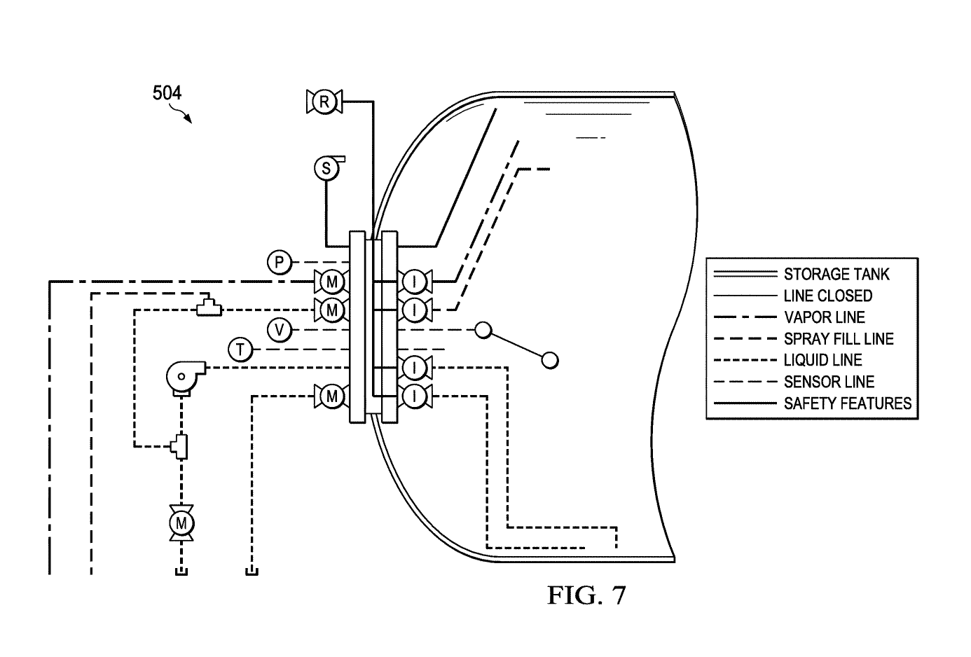

An exemplary configuration of such a pumping subsystem is described in more detail with regard to FIGS. 5-7. Here, FIG. 5 shows a front perspective view of the front portion of a tank trailer 500, showing an illustrative pumping system 504 coupled to a tank container 502. FIG. 6 shows a rear perspective view, with the tank container 502 hidden to better illustrate the internal interface between internal volume of the tank container 502 and pumping subsystem 504. FIG. 7 is simply a schematic diagram of the pumping subsystem system 504.

In the embodiment of FIGS. 5-6, the pumping subsystem 504 is directly coupled to the front cover 506, which is in turn coupled to the front polar boss 522. Placing the pumping subsystem 504 at the end of the trailer tank container 502 allows for a lighter weight composite tank container 502 because penetrations in structurally weaker portions of the trailer tank container 502, which would require additional material reinforcement, may be omitted. The pump 524 may be mounted on the face of the front cover 506. Internal piping 514, 516 are used to convey lading from the tank container 502 to a container outside of the tank container 502 (emptying operation) and from a container outside of the tank container 502 into the tank container 502 (filling operation). The pump 524 and piping material may be made from conventional metal materials using for LPG pumping and piping, or any other suitable material. In some embodiments, the internal piping 514, 516 are angled downward to withdraw payload from the bottom of the tank. The internal piping 514, 516 is coupled to the external portion of the pumping subsystem 504 at couplings 520 in the front cover 506. At the base of the pumping subsystem 504, inlet/outlet ports 526 are included for loading or unloading the tank container 502.

The illustrated positioning of the pumping subsystem 504 at the end of the tank container 502 provides a number of advantages. For example, a tank trailer 500 having a composite tank container 502 with penetrations only in the polar boss regions and a polar boss mounted pumping and piping system allows for a larger payload in addition to the ability to remove more of the LPG lading from the tank during emptying operations. The tank container 502 is lighter weight because the composite structure does not need additional structural support to reinforce weakened areas formed by penetrations in the composite material. Further, the illustrative system may remove more of the LPG lading since the tank can be slightly tipped towards the pumping system and allow more liquid to collect near the pump piping and be pumped out of the tank, as opposed to draining towards a pump near the bottom center along the length of a similar tank. In addition, the pump location at the polar boss results in the pump being less likely to ingest foreign matter from the LPG lading because the LPG is pulled up and not pulled down during the unloading pumping process (as a result of the liquid lines 514, 516 angling downward to the base of the tank container 502 to remove the LPG lading from the tank). In some embodiments, the tank container 502 may be biased or formed such that the liquid lines 514, 516 terminate at the lowest point in the tank container 502 when the tank container 502 is parked on a flat surface to facilitate unloading of the tank container 502.

As shown in the schematic of FIG. 7, the polar boss region also contains a variety of gauges and a relief valve. Internal piping is used to connect the relief valve located at the polar boss with the vapor space at the top of the tank during normal operation. This is to keep the relief valve functioning properly as it should remain in the vapor space.

What is claimed:

1. A tank trailer comprising:
a container having a composite, substantially tubular body and a polar boss coupled to a distal portion of the substantially tubular body,
wherein the substantially tubular body comprises an inner tubular portion and an outer shell, and
wherein the polar boss is positioned between the inner portion and outer shell of the substantially tubular body.

2. The tank trailer of claim 1, further comprising a base support and one or more circumferential support members coupling the base support to the composite container.

3. The tank trailer of claim 2, wherein the one or more circumferential support members comprise variable tension straps.

4. The tank trailer of claim 1, wherein the polar boss comprises an inner circular surface and an outer circular surface, the outer circular surface having one or more flat portions.

5. The tank trailer of claim 4, wherein the substantially tubular body comprises a generally cylindrical inner surface having one or more concave features, the one or more concave features being operable to engage the one or more flat portions of the outer circular surface of the polar boss.

6. The tank trailer of claim 1, further comprising a cover plate coupled to the polar boss.

7. The tank trailer of claim 6, wherein the cover plate comprises a pumping system interface, and further comprising a pumping system having one or more pipes coupled to the pumping system interface, wherein the one or more pipes fluidly coupled to the cover plate comprises an outlet pipe having a pipe inlet positioned near a lowermost point of an internal tank formed by the container when the tank trailer is positioned on a horizontal surface.

8. The tank trailer of claim 7, further comprising a fairing that encloses at least a portion of the pumping system, wherein the fairing is coupled to the distal portion of the substantially tubular body.

9. The tank trailer of claim 1, wherein the polar boss is a first polar boss, the tank trailer further comprising a second polar boss positioned at an opposite end of the substantially tubular body from the first polar boss, the second polar boss being coupled to a cover plate having an access port.

10. The tank trailer of claim 1, wherein the substantially tubular body comprises an epoxy resin selected from the group consisting of diglycidyl ether of bisphenol A, diglycidyl ether of bisphenol F, resorcinol diglycidyl ether, N,N-Diglycidyl-4-glycidyloxyaniline, brominated diglycidyl ether of bisphenol A, novolac epoxy, tetraglycidyl meta-xylenediamine, 1,4-butanediol diglycidyl ether, 4,4′-Methylenebis(N,N-diglycidylaniline), tris(4-hydroxyphenyl)methane triglycidyl ether, tris(2,3-epoxypropyl)isocyanurate, and combinations thereof; and epoxy curing agents.

11. The tank trailer of claim 1, wherein the substantially tubular body comprises a composite material selected from the group consisting of carbon fiber, fiberglass, and a combination thereof.

12. The tank trailer of claim 1, wherein the polar boss comprises a material selected from the group consisting of stainless steel, CorTen steel, and carbon steel.

13. The tank trailer of claim 1, wherein the composite container comprises a translucent portion having visual indicators of an amount of liquid disposed within the container, and wherein the composite container comprises an inner, glass reinforced layer.

14. The tank trailer of claim 1, wherein no pumping interface is formed in the substantially tubular body.

15. The tank trailer of claim 1, wherein the distal portion comprises a front portion of the substantially tubular body.

16. A method of forming a tank trailer comprising:
forming a container having a composite, substantially tubular body and a polar boss coupled to a distal portion of the substantially tubular body; and
coupling a cover plate to the polar boss of the container.

17. The method of claim 16, further comprising coupling a base support to the container using one or more circumferential support members.

18. The method of claim 16, wherein forming the container comprises coupling the polar boss to an inner tubular portion and outer shell of the substantially tubular body such that a flange portion of the tubular boss is positioned between the inner portion and outer shell of the substantially tubular body.

19. The method of claim 16, wherein the polar boss comprises an inner circular surface and an outer circular surface, the outer circular surface having one or more flat portions.

20. The method of claim 19, wherein the substantially tubular body comprises a generally cylindrical inner surface having one or more concave features, the one or more concave features being operable to engage the one or more flat portions of the outer circular surface of the polar boss.
